(19) United States
(12) Patent Application Publication
(10) Pub. No.: US 2006/0225326 A1
(43) Pub. Date: Oct. 12, 2006

(54) Light conductive and light storage elements for use in signage and path way markings

(76) Inventors: Michael G. Robinson, Elkhart, IN (US); Thomas W. Brignall JR., Marcellus, MI (US)

Correspondence Address: BARNES & THORNBURG, LLP, P.O. BOX 2786, CHICAGO, IL, 60690-2786, US

(21) Appl. No.: 11/400,150

(22) Filed: Apr. 7, 2006

Related U.S. Application Data
(60) Provisional application No. 60/736,483, filed on Nov. 14, 2005.
(60) Provisional application No. 60/669,299, filed on Apr. 8, 2005.

(51) Int. Cl. G09F 13/20

(52) U.S. Cl. 40/542

(57) ABSTRACT

A sign comprising one or more elements of indicia for storing light energy and discharging light. The element of indicia may have a thickness of about 3/16″ or otherwise in the range of about ⅛″ to about ¼″. The resin composition includes photoluminescent resin and a polymer resin providing light conduction and light storage properties. The resin composition may comprise about 35%-40% photoluminescent resin and about 60%-65% polymer resin. If backlighting is included as part of the sign the resin composition may instead comprise about 25% photoluminescent resin and about 75% polymer resin. The resin composition may be a thermo-plastic, thermo-set casting or molding resin.

### CROSS-REFERENCE TO RELATED APPLICATIONS

This application claims priority under 35 U.S.C. section 119(e) from U.S. Provisional Patent Application Ser. No. 60/736,483 filed Nov. 14, 2005 of the same title and U.S. Provisional Patent Application Ser. No. 60/669,299 filed Apr. 8, 2005 entitled Light Conductive and Light Storage elements for Use in Signage.

### BACKGROUND

Increasingly, laws, codes, and regulations are being passed to ensure that means of egress from buildings, trains, planes, buses, and ships are clearly marked, and to provide road and traffic safety. Accordingly, there is an ever increasing need, not only for well lit signs, but also for signs that can operate for extremely long durations at low cost and at high efficiency.

### SUMMARY

The present disclosure is directed to a sign comprising one or more elements of indicia for storing light energy and discharging light. The element of indicia may have a thickness of about 3/16″ or otherwise in the range of about ⅛″ to about ¼″. The resin composition includes photoluminescent resin and a polymer resin providing light energy storage and light conduction properties. The resin composition may comprise about 35%-40% photoluminescent resin and about 60%-65% polymer resin. If backlighting is included as part of the sign, the resin composition may instead comprise about 25% photoluminescent resin and about 75% polymer resin. The resin composition may, for example, be a thermo-plastic, thermo-set casting or molding resin.

Additional features of the present disclosure will become apparent to those skilled in the art upon consideration of the following detailed description of illustrative embodiments of the disclosure.

### BRIEF DESCRIPTION OF THE DRAWINGS

The detailed description particularly refers to the accompanying figure in which:

FIG. 1 is a front view of a sign in accordance with an embodiment of the present disclosure; and

FIG. 2 is a side perspective view of a sign in accordance with an other embodiment of the present disclosure, which includes backlighting, with the backing and light cabinet of the sign separated to illustrate the LED light tubes.

### DETAILED DESCRIPTION

While the present disclosure may be susceptible to embodiment in different forms, there is shown in the drawings and herein will be described in detail, embodiments with the understanding that the present description is to be considered an exemplification of the principles of the disclosure and is not intended to limit the disclosure to the details of construction and the number and arrangements of components set forth in the following.

The present disclosure relates to signs in the broadest sense, including any type of marking or other sign and any type of message, symbol or other indicia. By way of example and without limitation, the sign may be in the form of any building, road, directional or pathway marking or other sign.

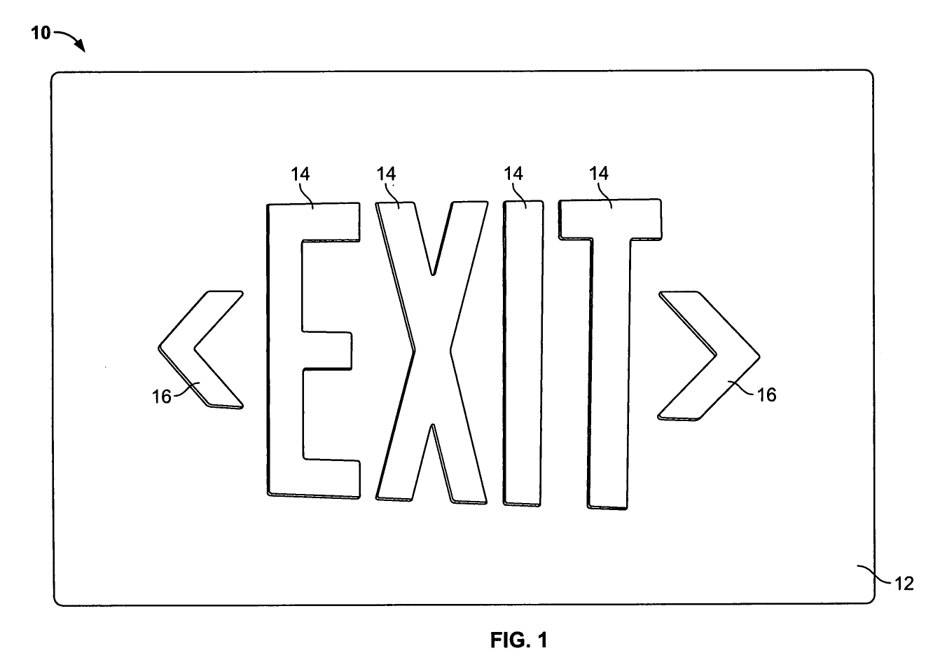

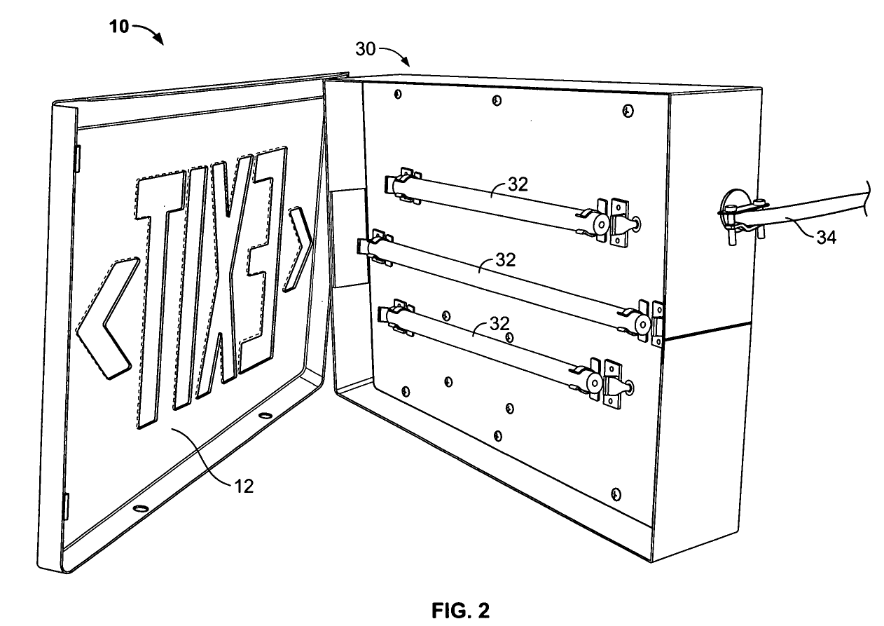

FIGS. 1-2, for example, illustrate a sign 10 in the form of an “Exit” sign having a backing 12 and elements of indicia in the form of letters 14 and arrow characters 16 secured to or otherwise associated with the backing. The elements of indicia are constructed and otherwise configured to store light energy and to discharge light. In particular, as set forth in more detail below, the elements of indicia are comprised of a resin composition, including any suitable photoluminescent resin and any suitable polymer resin to provide the elements of indicia with light energy storage and light conduction properties. Additionally, as also set forth in more detail below, the elements of indicia have a thickness adequate to suspend sufficient quantities of the photoluminescent material of the resin in the polymer matrix to produce an element of indicia that will achieve sufficient illumination. As a result of the resin mixture and the thickness of the element of indicia, when exposed to a light source, the elements of indicia charge or otherwise store light energy. When the light source is removed or deactivated, the elements glow or otherwise discharge light energy. The photoluminescent resin may, for example, be selected from the group consisting of sulfides of zinc, sulfides of strontium, sulfides of calcium, strontium oxide aluminate, flourine compounds and combinations thereof.

FIGS. 1-2 illustrate two different applications of the present disclosure. FIG. 1 illustrates an embodiment of the sign 10 configured to operate with any suitable ambient light, including, for example, fluorescent light or HID light. FIG. 2 illustrates an embodiment of the sign 10 configured with backlighting comprising the backing 12 and a light cabinet 30 including a plurality of LED tube lights 32 and a power cord 34. The backing 12 and the light cabinet 30 are shown separated to illustrate the separate components. In the application of FIG. 2, the backlighting may be in any other suitable form and may be secured to the backing 12 or otherwise positioned immediately adjacent the elements of indicia to energize the elements of indicia. The backlighting 20 may, for example, be fluorescent light, HID light, LED light, or blacklight. With the application of FIG. 1 or FIG. 2, the elements of indicia store light energy received from the ambient light and/or backlighting, and are able to emit light after the ambient light or backlighting has been deactivated or removed.

The resin mixture may be thermo-plastic, thermo-set casting or molding resins. The thermo-set resin mixture may be especially applicable for small to medium lot sizes as they can be metered very closely for repeatability. The thermo-set resins such as water clear aliphatic urethanes, and clear epoxies can be loaded from as little as 5% photoluminescent resin up to 50% depending on the need for a particular application. Thermo-set resins such as nylon, polycarbonate, clear polystyrene, injectable urethanes, and PVDF resins can be compounded to accommodate loadings of 10% up to 30% before the base resin starts to change so it will no longer melt and flow correctly for injection molding or extruding. Injection molding and extrusion can be used to produce high quantities of indicia elements that do not require the high charge and discharge rates as the elements required for UL approved signs. The resin mixture may include fire retardants or may otherwise be constructed to achieve the class “A” fire rating without degrading the element's ability to charge and discharge as needed.

By way of example, in the embodiment of FIG. 1, the resin may be a thermo-plastic resin comprising in the range of about 35%-40% photoluminescent light and in the range of about 60%-65% polymer resin. In the embodiment of FIG. 2, the resin may, for example, be a thermo-set casting or molding resins comprising about 25% photoluminescent light and about 75% polymer resin.

The elements of indicia may meet or exceed the light output requirements set forth in U.L. 924 in accordance with an embodiment of the present disclosure, meaning that, when the light source is removed, the elements will glow with a brightness of 5 ft. candles for a duration of 90 minutes and more as required to pass UL 924. The elements of indicia glow with sufficient brightness and longevity to be used for directional, informational, and emergency signage and pathway markings as required by building and sign codes, passing UL 924.

The foregoing description is for exemplary purposes only and is not intended to limit the scope of protection accorded this disclosure. The scope of protection is to be measured by the following claims, which should be interpreted as broadly as the contribution permits.

1. A sign comprising at least one element of indicia for storing light energy and discharging light, the element of indicia having a thickness in the range of about ⅛″ to about ¼″ and comprising a resin composition including a polymer resin and a photoluminescent resin providing light energy storage and light conduction properties.

2. The sign of claim 1 wherein the element of indicia has a thickness of about 3/16″.

3. The sign of claim 1 wherein the resin composition comprises in the range of about 35-40% photoluminescent resin and in the range of about 60-65% polymer resin.

4. The sign of claim 3 wherein the resin composition is a thermoplastic.

5. The sign of claim 4 wherein the resin composition comprises in the range of about 35% to 40% photoluminescent resin.

6. The sign of claim 1 wherein the resin composition is a thermo-cast.

7. The sign of claim 6 resin composition comprises about 25% photoluminescent resin.

8. The sign of claim 1 further comprising a light source positioned immediately adjacent the element of indicia for energizing the element of indicia.

9. The sign of claim 8 wherein the resin composition is a thermo-cast and comprises about 25% photoluminescent resin, and wherein the element of indicia has a thickness of about 3/16″.

10. The sign of claim 8 wherein the light source comprises a high intensity discharge light.

11. The sign of claim 8 wherein the light source comprises at least one LED.

12. The sign of claim 8 wherein the light source comprises a black light.

13. The element of claim 8 wherein the thermo-set resin is selected from the group consisting of water clear aliphatic urethanes, clear epoxies, nylon, polycarbonate, clear polystyrene, injectable urethanes, (PVDF) polyvinylidene fluoride, and combinations thereof.

14. The element of claim 8 wherein the thermo-set resins are compounded.

15. The element of claim 1 wherein the element of indicia further comprises a fire retardant.

16. The element of claim I wherein the element of indicia is in a form selected from the group consisting of shapes, letters, numbers, characters and combinations thereof.

17. The element of claim I wherein the light discharged from the element of indicia is of sufficient brightness to meet the requirements of U.L. 924.

18. The element of claim I wherein the light discharged from the element of indicia is of sufficient brightness to exceed the requirements of U.L. 924.

19. The element of claim 1 wherein the photoluminescent resin is a high grade photoluminescent polymer.

20. The element of claim 19 wherein the photoluminescent resin is selected from the group consisting of sulfides of zinc, sulfides of strontium, sulfides of calcium, strontium oxide aluminate, flourine compounds and combinations thereof.

21. A sign comprising at least one element of indicia for storing light energy and discharging light, the element of indicia having a thickness in the range of about 3/16″ and comprising a thermoplastic resin composition comprising in the range of about 35%-40% photoluminescent resin and in the range of about 60%-65% polymer resin, the element of indicia having light energy storage and light conduction properties.

22. A sign comprising a light source and at least one element of indicia positioned immediately adjacent the light source for storing light energy received from the light source and for discharging light, the element of indicia having a thickness in the range of about 3/16″ and comprising a thermoplastic resin composition comprising about 25% photoluminescent resin and about 75% polymer resin, the element of indicia having light energy storage and light conduction properties.
